(19) United States
(12) Patent Application Publication
(10) Pub. No.: US 2025/0376108 A1
(43) Pub. Date: Dec. 11, 2025

(54) Car Safety and Management System

(71) Applicant: Pojanee Fleury, Orange, NJ (US)

(72) Inventor: Pojanee Fleury, Orange, NJ (US)

(21) Appl. No.: 19/229,997

(22) Filed: Jun. 5, 2025

Related U.S. Application Data
(60) Provisional application No. 63/656,738, filed on Jun. 6, 2024.

(51) Int. Cl. B60Q 1/50; B60K 35/10; B60K 35/22; B60Q 1/26; B60Q 1/52

(52) U.S. Cl. CPC B60Q 1/5035; B60K 35/10; B60K 35/22; B60Q 1/268; B60Q 1/52

(57) ABSTRACT

A device and communication system which includes a casing that holds the processor with a touch sensitive screen that displays a round console with five color coded buttons which is placed on the dashboard within easy reach of the driver. These buttons relay messages through light emitting diode (LED) vehicle display signage on strategically placed message LED displays on the vehicle to communicate with other vehicles and emergency vehicles nearby. The system can flash different color lights on the LED vehicle displays, showing the state of distress in the vehicle, or it can flash predetermined messages which correlate to the color coded buttons on the console. The system also has a button which allows custom messages to be written and displayed. The LED vehicle displays flashing lights are, red, green, blue or orange lights to highlight the nature of the message.

### FIELD OF THE INVENTION

The present invention relates to a system and method for facilitating assistance in vehicle distress situations.

### BACKGROUND

Today vehicles have very limited ways to communicate with other vehicles, pedestrians, observers or emergency vehicles. This applies to vehicles driving or parked, or in another situation.

The inventor has observed that in emergency situations such as accidents or breakdowns, traditional methods of signaling for help or conveying important messages or other drivers are often inefficient or unclear. This leads to delays in assistance reaching those in need and increased risks on the road. Additionally there is a lack of standardized communication protocols for conveying different types of messages, leading to confusion among drivers,

### SUMMARY OF THE INVENTIONS

A device and communication system which includes a casing that holds memory storage and a processor with a touch sensitive screen that displays a round console with five color coded buttons which is placed on the dashboard within easy reach of the driver, These buttons relay messages through light emitting diode (LED) vehicle display signage on strategically placed LED message displays on the vehicle to communicate with other vehicles and emergency vehicles nearby.

The first embodiment of the system has the LED vehicle displays flashing lights of a color that matches the buttons on the console, red, green, blue or orange lights to highlight the nature of the message, red for medical emergency, green for help is coming, blue for assistance needed and orange for the car is disabled.

The LED displays are located:
on the front windshield, near the lower right corner;
on the back window near the lower right hand cornet;
on the top of the car—where the display can be seen from the front of the vehicle, and from the back of the vehicle;
on or near the front bumper;
on or near the back bumper;
on the front headlights, taking a small part of the headlight space;
on the brake lights, taking a small part of the brake light space.

LED displays may also be placed in other locations.

A second embodiment places predetermined messages on the LED displays. The messages are selected by pushing the buttons on the console. In this embodiment the system allows custom messages to be displayed by pushing the middle button.

Standard messages could read:
Help is on the way, green button;
Vehicle is disabled, orange button;
Need help for service, orange button;
Medical emergency, red button.

This embodiment would also include a touch sensitive keyboard display to allow users to add custom messages for one time use; or to add a new standard phrase. Programing could allow selecting a button and then adding a phrase to add a new phrase associated with a particular color button.

Another embodiment would allow the user to push a color button on the console once for color lights to be on the LED display, and to push a color coded button on the console twice for messages. Another embodiment would be for the user to push the color coded buttons and the LED displays would alternate between flashing lights and messages.

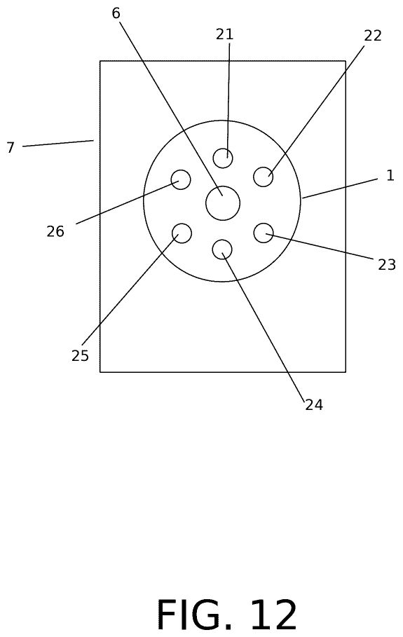

Another additional embodiment is a controller (FIG. 12) with six buttons surrounding a center button (for custom messages) allows a user to have additional standard phrases.

### DESCRIPTION OF THE NUMBERS IN THE FIGURES

1. Round console that the contains press buttons.
2. Red button, message indicates a medical emergency.
3. Blue button—message indicates urgent emergency need for assistance.
4. Orange button—message indicates that the car is disabled.
5. Green button—message indicates help is on the way.
6. White button—allows user to input a custom message with keyboard
7. Casing that holds the processor and displays the round icon and has a touch sensitive screen.
8. LED back window display.
9. LED front window display,
10. Front window,
11. LED left brake light display,
11A. LED right brake light display,
12. Dual facing top display.
13. LED right side headlight display.
14. LED left side headlight display.
15. LED rear bumper display on or above rear bumper.
16. LED front bumper display on or above front bumper.
17. First dashboard attachment mechanism.
18. Second dashboard attachment mechanism.
19. Screen to display new custom message.
20. Keyboard location.
21. Button with a first color,
22. Button with a second color.
23. Button with a third color.
24. Button with a fourth color.
25. Button with a fifth color.
26. Button with a sixth color.

### DETAILED DESCRIPTION

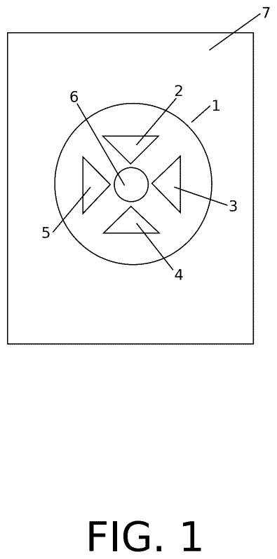

FIG. 1 shows the console 1, which is a two dimensional image on a touch sensitive screen within a casing 7, with five buttons to push, one red 2, one blue 3, one orange 4, 1 green 5 and one white 5. The touch sensitive screen within a casing 7, may be a cell phone if a cell phone app is used or it may be a separate display with its own processor.

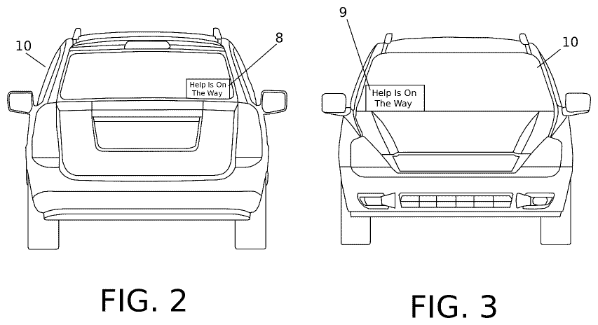

FIG. 2 shows a vehicle from the rear with an LED back window display 8. The front windshield 10 is shown just to emphasize the view is from the rear of the vehicle.

FIG. 3 shows a vehicle from the front with an LED front window display 9. The front windshield 10 is shown just to emphasize the view is from the front of the vehicle,

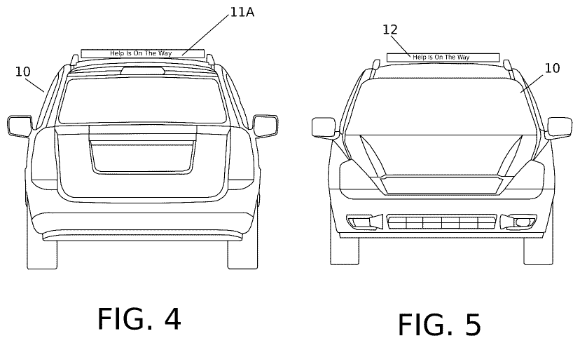

FIG. 4 shows the LED top dual facing display 12 from the back. The front windshield 10 is shown just to emphasize the view is from the rear of the vehicle.

FIG. 5 shows the LED top dual facing display 12 from the front. The front windshield 10 is shown just to emphasize the view is from the front of the vehicle.

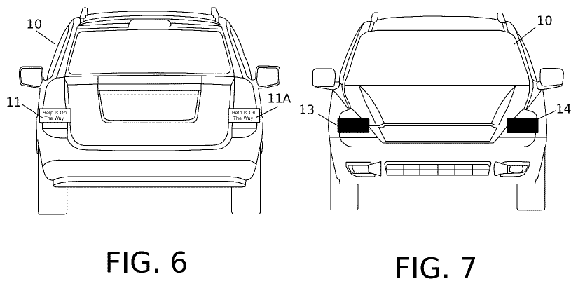

FIG. 6 shows the LED left side brake light display 11 and the LED right side brake light display 11A. The front windshield 10 is shown just to emphasize the view is from the rear of the vehicle.

FIG. 7 shows the LED left side headlight display 13 and the LED right side headlight display 14 when the displays are flashing a color. The front windshield 10 is shown just to emphasize the view is from the front of the vehicle.

Note, with the LED back brake light displays of FIG. 6 (with messages), the LED front head light displays as seen on FIG. 7 would also be showing the same message. On FIG. 7, the flashing LED front headlight displays would be the same as on the LED brake light displays, Or more simply, the LED brake light displays and the LED headlight displays are always flashing the same, either a message or a flashing display.

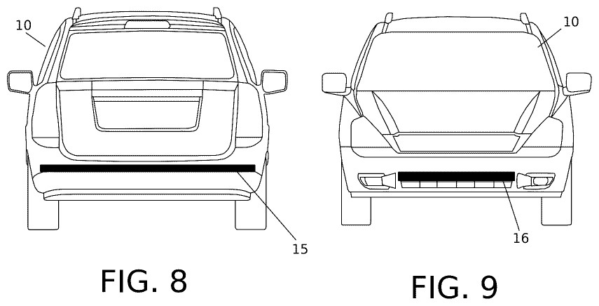

FIG. 8 shows the LED back bumper display 14. The front windshield 10 is shown just to emphasize the view is from the rear of the vehicle. The LED back bumper display may be on the back bumper, or just above it. This LED display could also be on the side of the vehicle.

FIG. 9 shows the LED front bumper display 15. The front windshield 10 is shown just to emphasize the view is from the front of the vehicle. The LED front bumper display may be on the back bumper or just above it. This LED display could also be on the side of the vehicle.

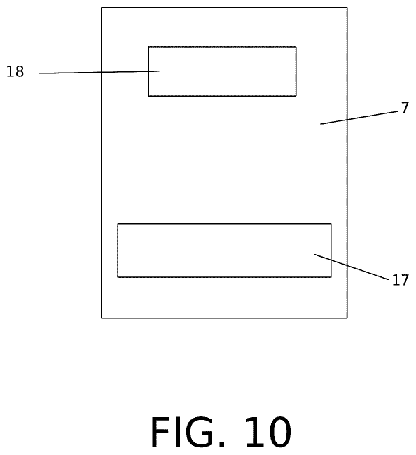

FIG. 10 shows the back of the casing that holds the processor 7 and the first dashboard attachment mechanism 17 and the second dashboard attachment mechanism 18.

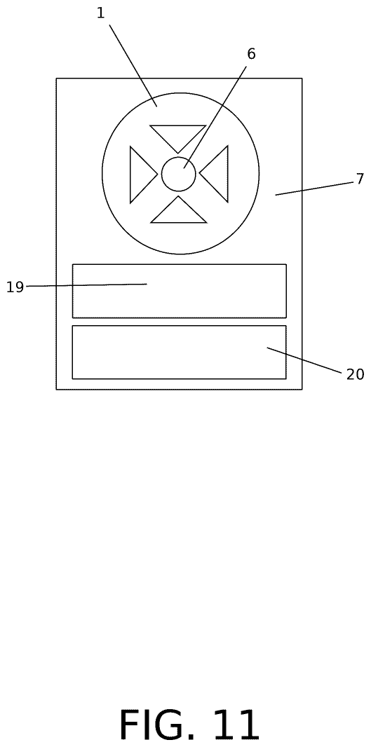

FIG. 11 shows the casing that holds the processor and displays the round icon and has a touch sensitive screen, 7 and a keyboard location 20 and a screen to display new custom messages 19 when a new message button 6 is pushed. The screen and keyboard functions are not displayed on the screen until button 6 is pushed.

FIG. 12 shows an alternate console 1, where the console has six buttons, around the center button 6. This allows the system to have more standard messages for display.

I claim:

1. A car safety and management system comprising:
a processor-based portable device having a communication unit and memory storage;
the processor-based portable device with a casing and a touch sensitive display screen;
the touch sensitive display screen showing a two-dimensional console with multiple touch sensitive button images;
each touch sensitive button image corresponds to a programmed action;
LED display screens located on one or more positions on a vehicle;
a system user determines what color should be shows on the LED display screen(s) by pushing one of the touch sensitive button images;
the processor-based portable device communicates messages to the LED display screen(s);
The LED display screen(s) display the user selected color.

2. The car safety and management system of claim 1 where the system flashes messages.

3. The car safety and management system of claim 2 where the system alternates between flashing colors and messages.

4. The car safety and management system of claim 2 where pushing the touch sensitive button images activates on the LED vehicle displays a flashing color, and where pushing the button twice activates flashing messages.

5. The car safety and management system of claim 1 where the console has five touch sensitive buttons.

6. The car safety and management system of claim 2 with a touch sensitive keyboard.

7. The car safety and management system of claim 6 with a screen display that shows the message being entered on the keyboard.

8. The car safety and management system of claim 2 where the console has a button that allows a custom message to be entered with the keyboard.

9. The car safety and management system of claim 1 where the back of the display has dashboard attachment mechanisms.

10. The car safety and management system of claim 1 where the console has seven buttons.

11. The car safety and management system of claim 1 has seven buttons, six in a circle around a center button.

12. The car safety and management system of claim 2 where the messages comprise help is on the way; vehicle is disabled, need help for service, and medical emergency.
